(19) United States
(12) Patent Application Publication
(10) Pub. No.: US 2007/0047407 A1
(43) Pub. Date: Mar. 1, 2007

(54) System and method for writing power control during recording

(75) Inventors: Hung-Hsiang Chang, Jhubei City (TW); Kun-Yi Chan, Jhutang Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/215,815

(22) Filed: Aug. 30, 2005

(51) Int. Cl. G11B 7/12

(52) U.S. Cl. 369/47.53

(57) ABSTRACT

A recording system is provided, improving laser control when writing data on an optical recording medium. A data buffer stores data to be recorded, wherein the data is divided into first and second data units in response to a trigger signal, wherein the first data unit is followed by the second data unit. A laser controller first receives the second data unit from the data buffer, writes the second data unit to an optical disc using a write laser, reads and evaluates the recorded second data unit, adjusts characteristics of the write laser according to the evaluation, receives the first data unit from the data buffer, and writes the first data unit to the optical disc using the adjusted write laser.

### BACKGROUND

The invention relates to recording data on an optical information carrier, and more particularly to a system and method for controlling the power of a radiation source while recording data on an optical information carrier.

Information is recorded onto a recordable optical information carrier such as a DVDR (DVD-recordable) or a DVDRW (DVD-rewritable) by projecting a laser beam onto the recording surface. At the contact areas, the properties of the optical recording medium are physically changed by increased temperature. This generates recording marks on the recording surface.

The laser beam is modulated by recording pulses having time widths corresponding to information to be recorded, such that laser pulses having lengths corresponding to information to be recorded are generated and projected onto the optical information carrier.

Laser power required to write an optical information carrier varies according to factors such as, for example, individual recorder, disc, and sometimes the specific location on the disc. Consequently, recorders perform an optimum power calibration (OPC) procedure before recording to determine a suitable write laser power setting for each disc and recorder combination. Before user data is recorded, a test write is performed on a small segment of an optical information carrier. For optical disks, this segment is along with the inner radius of the disk. The test write records at various power levels and write pulse shapes. By reading back the data recorded by the test write, appropriate power levels and pulse shapes are determined, for the information to be recorded.

In practice the OPC procedure may vary between manufacturers and recorder models. For example, a recorder obtains a beginning recording value of 5.9 mW from a disc and write 15 times (15 Absolute Time In Pregroove (ATIP) frames) in the Power Calibration Area (PCA). Referring to FIG. 1, a disk 10 comprises a PCA 11 that PCA 11 may be a fraction of a full revolution of disc 10. The conventional OPC process may, however, produce inaccurate results, because a short test write is used therein to determine the so-called optimum write power. The use of power calibration data from less than a full revolution of the disk may cause errors because of one of the following issues: vertical and radial run out which cause focus and tracking errors, circumferential variation in the thickness of the recording layer or in the optical properties of the substrate, and localized errors in the test write area.

In order to address these issues, a technique referred to as running OPC (ROPC) is used. According to the ROPC technique, during the initial OPC process a recorder also monitors and stores the reflected light coming from the disk while forming the marks. After determining what power setting yields the required +4% beta, the recorder retrieves the reflected signal that is associated therewith, establishes and saves a mark formation signature. During recording, the system monitors the marks as they form on the disk using the reflected light and compares these signals against the signature established during the initial OPC process.

The ROPC technique, however, has several shortcomings. The ROPC method adjusts the write power based on the read back data of the reflected write power. The predictive parameters are non-linear and have a low signal-to-noise ratio. They also may vary with manufacturer process.

### SUMMARY

Embodiments of the invention provide a recording system comprising a laser source, a data buffer, and a laser controller. The recording system improves laser control when writing data on an optical recording medium. The laser source provides a write laser to record data on an optical disc. The data buffer stores data to be recorded, wherein the data is divided into first and second data units in response to a trigger signal, wherein the first data unit is followed by the second data unit. The laser controller first receives the second data unit from the data buffer, writes the second data unit to an optical disc using a write laser, reads and evaluates the recorded second data unit, adjusts characteristics of the write laser according to the evaluation, receives the first data unit from the data buffer, and writes the first data unit to the optical disc using the adjusted write laser.

Also disclosed is a method of recording data. A data buffer is provided, storing data to be recorded, wherein the data is divided into first and second data units in response to a trigger signal, wherein the first data unit is followed by the second data unit. The second data unit is received from the data buffer. The second data unit is written to an optical disc using a write laser. The second data unit recorded on the optical disc is then read and evaluated. Characteristics of the write laser are adjusted according to the evaluation. The first data unit is then received from the data buffer. The first data unit is recorded to the optical disc using the adjusted write laser.

Another embodiment of a method for writing data onto an optical disc comprises: dividing data to be recorded into first and second data units according to a degree of importance of the data; writing the second data unit of less importance to the optical disc by a write laser; reading and evaluating the second data unit recorded on the optical disc; adjusting characteristics of the write laser according to the evaluation; and writing the first data unit of more importance to the optical disc by the adjusted write laser, such that the end of the first data unit is concatenated to the beginning of the second data unit on the optical disc.

### DESCRIPTION OF THE DRAWINGS

The invention can be more fully understood by reading the subsequent detailed description and examples with references made to the accompanying drawings, wherein:

FIG. 1 is a side view of an optical disc used in a related art;

FIG. 2 is a schematic diagram showing an embodiment of a recording system;

FIG. 3 is a flowchart of an embodiment of a method for recording data in optical drives; and

FIG. 4 illustrates the recording operation of FIG. 3.

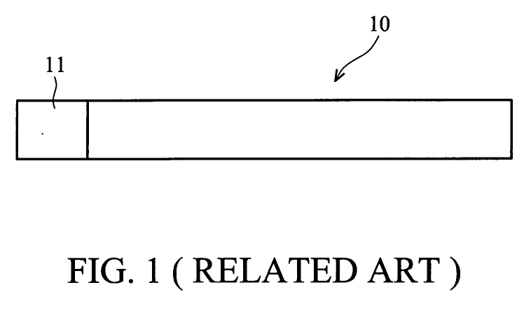

### DETAILED DESCRIPTION

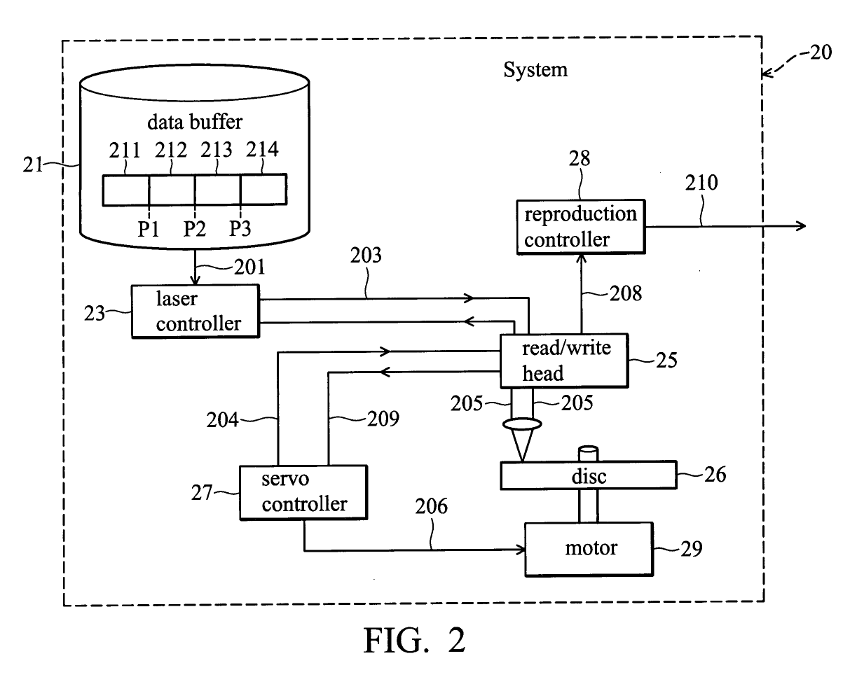

Embodiments of the invention are now described with reference to FIGS. 2 through 4, which generally relate to laser control during recording data on an optical disc.

In the following detailed description of an embodiment of the invention, reference is made to the accompanying drawings which form a part hereof, and in which is shown by way of illustration of specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense, and the scope of the present invention is only defined by the appended claims. The leading digit(s) of reference numbers appearing in the Figures corresponds to the Figure number, with the exception that the same reference number is used throughout to refer to an identical component which appears in multiple Figures.

FIG. 2 is a schematic diagram showing an embodiment of a recording system. The recording system records data by writing marks to a recording surface of an optical information carrier, and reproducing data therefrom. The optical information carrier can be an optical disc that can be a recordable or rewriteable medium. For example, the optical disc may be a compact disc, such as a CD-R, CD-RW, DVDR, DVDRW, or a DVD-RAM. System 20 comprises data buffer 21, laser controller 23, read/write head 25, servo controller 27, and motor 29.

The read/write head 25 is designed to read from and write to the disc 26. In an embodiment, the read/write head 25 may be two devices, one designed to read, and one designed to write. The read/write head 25 includes a laser for writing to the disc 26. The recording laser is controlled by laser controller 23, which turns on the writing laser at a certain time, as will be discussed in more detail in the following.

Data buffer 21 stores data to be recorded on disc 26. Generally, data buffer 21 is continuously filled. If a trigger signal is asserted, consecutive data in the buffer 21 can be separated by virtual points P1˜P3 and thus four data units result. The data stored in data buffer 2l is transmitted as signal 201 to the laser controller 23. The laser controller 23 performs optimal power control (OPC) process, writing test data at various power levels and write pulse shapes at the inner radius of the disc. By reading back the test data, the optimum power level and pulse shape are set, for recording user data. The process is performed only once during the first write. The laser controller 23 sets the power of the recording laser, and further defines the write strategy used by write laser. Laser controller 23 generates signal 203 to control read/write head 25 based on signal 201, thereby driving the read/write head 25 to provide a write laser 205 writing marks representing data conveyed by signal 201 onto disc 26. Additionally, the laser controller 23 controls the power of the write laser during recording. In response to a trigger signal, laser controller 23 starts a process of adjusting laser power and therefore divides data stored in data buffer 21 into data units 211˜214. For example, after recording data unit 211 onto optical disc 26, the laser controller receives data unit 213 rather than data unit 212 from the data buffer 21, and drives the read/write head 25 to write data unit 213 onto the disc 26 using a write laser. The read/write head 25 then reads the recorded data unit from the disc 26, and transmits the read signal to the laser controller 23. The laser controller 23 evaluates the recorded data unit 213 according to the read signal transmitted from the read/write head 25. The laser controller 23 then determines whether the write laser needs to be adjusted, and adjusts characteristics of the write laser according to the evaluation if appropriate. After adjustment, the laser controller 23 receives data unit 212 from the data buffer 21, and writes data unit 212 to the disc 26 using the adjusted write laser. After data unit 212 has been recorded on the disc 26, the laser controller 23 rewrites data unit 213 if the previous writing quality does not meet preset criteria; otherwise, the laser controller 13 receives and records data unit 214 seamlessly from the end of data unit 213. The write laser 205 is focused by lens 255 onto disc 26. The disc 26 is rotated around its center by a motor 29. A reproduction controller 28 receives a read signal 208 from read/write head 25, and performs predetermined processing thereon, such as demodulating and decoding, to generate and output reproduced data 210.

The servo controller 27 receives read signal 209 from read/write head 25, and controls the mechanical aspects of the movement of the disc 26 and read/write head. Based on the read signal 209, servo controller 27 generates a servo signal 204, such as a tracking error signal or a focus error signal, on the read/write head 25, and provides a spindle servo signal 206 to the motor 29.

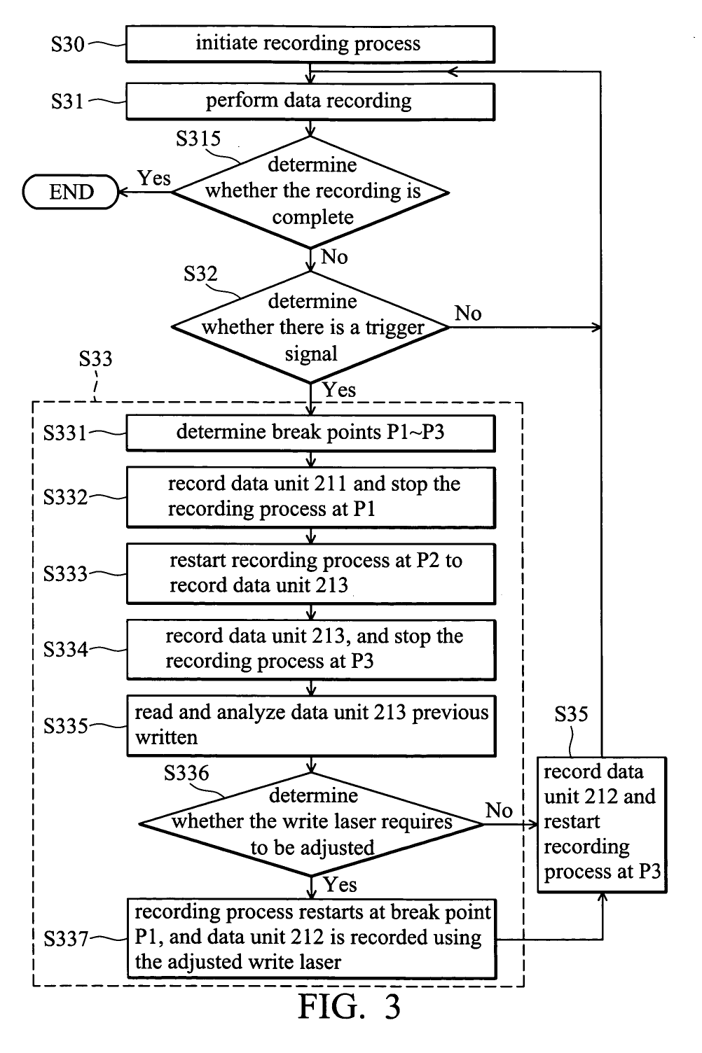

The processing algorithm implemented in system 20 is detailed in the flowchart of FIG. 3. Here, recording using a jumping mechanism permits stopping and restarting a recording process at preset locations during recording. Data to be recorded is stored in a buffer and divided into data units in response to a trigger signal. Data units are recorded not according to their instinct sequence, but according to a preprogrammed sequence. The data unit used for a “test write” may be determined arbitrarily or according to its characteristics. The length of data being read back may vary. Here, data unit 213 comprises at least 16 sectors of data, or one ECC (Error Correction Code) block. There is an enough empty space lying between a starting point for test write and a prior write stopping point. The data unit for test write can then be evaluated for various characteristics in order to qualify the write laser used in the recording process as appropriate. For example, the characteristics may include error rate, jitter, or other metrics used to evaluate the quality of the read-back signal obtained from an optical disc. The quality of the read-back signal indicates whether the writer laser is properly calibrated. For example, the quality of read-back signal may be used to determine whether the power of write laser and write strategy require further adjustment. The evaluation may be executed at an arbitrary time and position, and use an arbitrary amount of data. The write laser can then be adjusted appropriately, and thus a read-back signal with better quality may be produced using the adjusted write laser. By selecting a data section of less importance and using it in a test write prior to recording important data, the overall quality of recording may be improved.

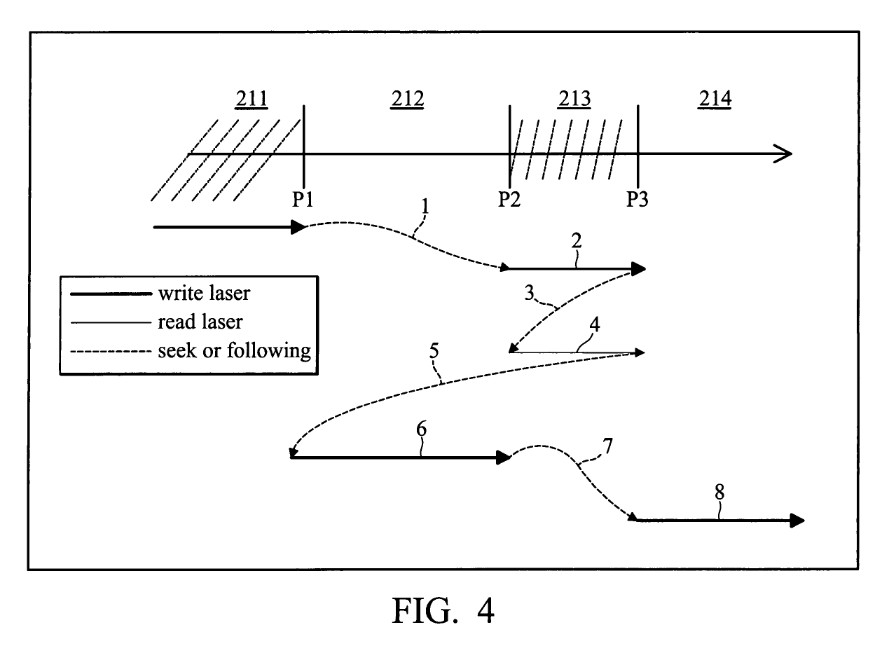

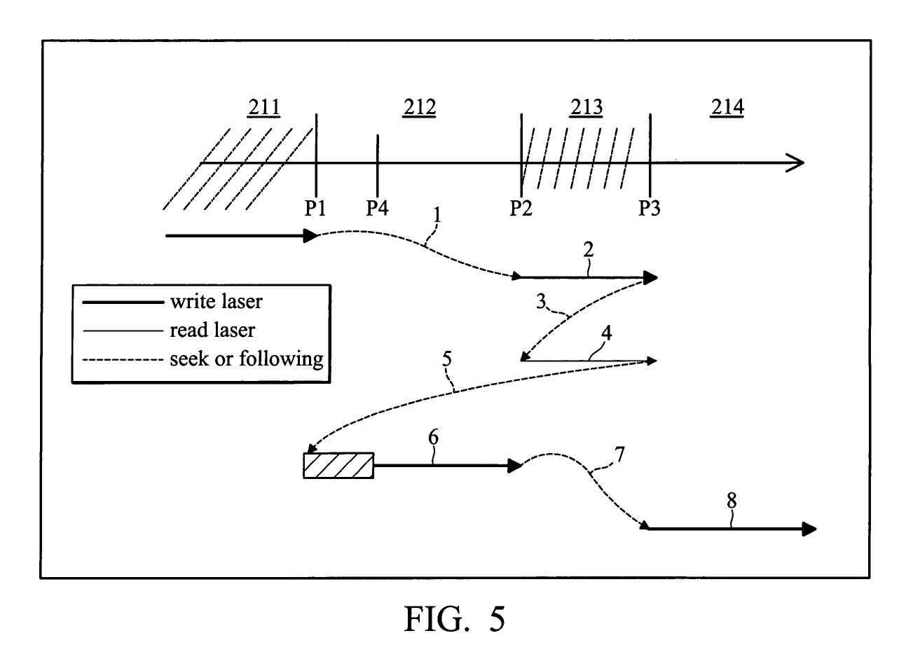

The method of write laser control is as follows. Referring to FIGS. 3 and 4, a recording process is initiated (step S30) data is recorded onto an optical disc (step S31). The write power and write strategy for recording data may be determined using a conventional Optimum Power Control (OPC) mechanism. The conventional OPC process writes test data to a test area of the optical disc to determine a laser power and write strategy. In step S315, it is determined whether the recording is complete. The recording may be complete if all available data has been recorded, or if the disc is full. If the recording is complete, the method proceeds to an end, otherwise the method proceeds to step S32. In step S32, it is determined whether there is a trigger signal for reevaluation of the write laser. If no trigger signal is detected, the method returns to step S31, otherwise the method proceeds to step S33.

The trigger signal may be generated based on a conventional OPC mechanism, or evaluation of other signals monitored during data recording. For example, the trigger signal that prompts a stop and reevaluation may include at least one timer, wherein the timer may periodically trigger a reevaluation. A temperature sensor may trigger a reevaluation if the temperature of the laser source or the disc exceeds a threshold. The trigger signal may be generated by a writing speed detector and/or running OPC mechanism. During recording of user data, the amplitude of light reflected from the media during writing marks that encode the user data may be monitored. The signature of the data, as it is being written, is compared to the data recorded during the OPC process. If the signature has changed significantly, the running OPC mechanism generates a trigger signal to stop writing and evaluate the laser power and write strategy. The trigger signals may also be generated in response to mechanical variations, such as tilt, focus, vertical runout, and radial runout. These mechanical variations are generally cyclic in nature, varying with the angular position of the disc. The trigger signal may be generated in response to other mechanical variations, such as beam deflection, vertical deviation, axial and radial acceleration difference, and eccentricity.

In step S33, a write laser adjusting process is performed. In step S331, break points P1˜P3 are determined according to characteristics of data stored in data buffer 21. Data stored in data buffer 21 is divided into data units 211˜214 by the break points P1˜P3 according to the degree of importance. Data unit 212 contains one or more ECC blocks, which may comprise VOB, IFO, file structure information, SDCB, RMD, and navigator table, for example. Data units 211, 213, and 214 comprise normal user data which is of less importance, within which error does not gives rise to serious problems in data reproduction. In step S332, data unit 211 is recorded, and the recording process is stopped when the recording of data unit 211 is complete. Data unit 213 is then received from data buffer 21, and a recording process restarts to record data unit 213 (step S333). In step S334, data unit 213 is recorded, and the recording process is stopped when the recording of data unit 213 is complete. The data unit 213 previously written is read and analyzed (step S335). The analysis is performed by evaluating characteristics of the recorded data unit 213, such as jitter, error rate, and read RF thereof. In step S336, it is determined whether the write laser requires adjustment. When analysis of the read-back signal indicates that adjustment is required for the write power and/or write strategy, the method proceeds to step S337, otherwise the method proceeds to step S35. In step S337, the recording process restarts at an appropriate position to record-data unit 212 using the adjusted write laser. After the data unit 212 is recorded, the recording process in step S35 continues writing data onto the disc from a position following the previously recorded data unit 213, and the method returns to step S31.

When the recording process operates with a rewritable optical disc, if appropriate, data unit 213 may be overwritten after the write laser has been adjusted. In this case, data unit 213 may be stored in another data buffer in the recording system after it is removed from the data buffer 21. If quality of the read-back signal does not meet a minimum requirement, data unit 213 may be overwritten after data unit 212 is recorded.

Additionally, when the difference between the characteristics of the original write laser (i.e. the write laser used in step S31) and the adjusted write laser exceeds preset criteria, the adjustment may be implemented gradually.

FIG. 4 illustrates an embodiment of the recording operation of FIG. 3. Data to be recorded is stored in a buffer and divided into data units in response to a trigger signal, as shown in FIG. 2. Data units are recorded not according to their original sequence, but according to a preprogrammed sequence. Here, from the aspect of time, data units 211, 213, 212, and 214 are recorded sequentially in response to a trigger signal. A data recording process is first initiated. The write power and write strategy for recording data unit 211 may be determined using a conventional Optimum Power Control (OPC) mechanism. A trigger signal is then generated to initiate a reevaluation process. As mentioned earlier, data stored in data buffer 21 can be divided into data units 211˜214 according to the degree of importance. When the recording of data unit 211 is complete, the recording process is stopped at point P1 of the optical disc. Data unit 213 is then recorded, and the recording process is stopped at point P3 of the optical disc. The data unit 213 previously written is read and analyzed. It is determined whether the write laser requires adjustment. When analysis of the read-back signal indicates that adjustment is required for the write power and/or write strategy, the recording process restarts writing data unit 212 seamlessly from point P1 using the adjusted write laser. The recording process stops at point P2 when the recording of data unit 212 is complete, and moves to point P3 to write data unit 214.

FIG. 5 illustrates another embodiment of the recording operation of FIG. 3. Data to be recorded is stored in a buffer and divided into data units in response to a trigger signal, as shown in FIG. 2. Data units are recorded not according to their original sequence, but according to a preprogrammed sequence. Here, from the aspect of time, data units 211, 213, 212, and 214 are recorded sequentially in response to a trigger signal. A data recording process is first initiated. The write power and write strategy for recording data unit 211 may be determined using a conventional Optimum Power Control (OPC) mechanism. A trigger signal is then generated to initiate a reevaluation process. As mentioned earlier, data stored in data buffer 21 can be divided into data units 211˜214 according to the degree of importance. When the recording of data unit 211 is complete, the recording process is stopped at point P1 of the optical disc. Data unit 213 is then recorded, and the recording process is stopped at point P3 of the optical disc. The data unit 213 previously written is read and analyzed. It is determined whether the write laser requires adjustment. When analysis of the read-back signal indicates that adjustment is required for the write power and/or writes strategy, the recording process restarts at point P4 of the optical disc, and data unit 212 is recorded using the adjusted write laser. There is a substantial gap between the stopping point P1 and the restarting point P4. The length of the gap is preset to meet special requirements and preferably equal to or greater than 100 T. Restarting the writing process at P4 instead of P1 can ensure that the physical address of the restarting point can be correctly determined. The recording process stops at point P2 when the recording of data unit 212 is complete, and moves to point P3 to write data unit 214.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of recording data, comprising:
providing a data buffer storing data to be recorded, wherein the data is divided into first and second data units in response to a trigger signal, wherein the first data unit is followed by the second data unit;
receiving the second data unit from the data buffer;
writing the second data unit to an optical disc using a write laser;
reading and evaluating the second data unit recorded on the optical disc;
adjusting characteristics of the write laser according to the evaluation;
receiving the first data unit from the data-buffer; and
writing the first data unit to the optical disc using the adjusted write laser.

2. The method of claim 1, wherein the first data unit comprises VOB, IFO, file structure information, SDCB, RMD, and navigator table.

3. The method of claim 1, wherein the first data unit comprises data of higher importance than the second data unit.

4. The method of claim 1, further comprising identifying the data units in response to the trigger signal.

5. The method of claim 4, wherein the first and second data units are identified according to the content thereof.

6. The method of claim 1, wherein the characteristics comprise a power level of the write laser.

7. The method of claim 1, wherein the evaluation comprises detecting at least one of the following characteristics of the recorded data: jitter, error rate, and read RF.

8. The method of claim 1, further comprising rewriting the second data unit using the adjusted write laser after the first data unit is written.

9. The method of claim 1, wherein writing the first data unit comprises leaving a gap between a previously recorded portion on the optical disc and an area of the optical disc that stores the first data unit, and concatenating the end of the first data unit to the beginning of the second data unit on the optical disc.

10. A recording system, comprising:
a laser source providing a write laser to record data on an optical disc;
a data buffer storing data to be recorded, wherein the data is divided into first and second data units in response to a trigger signal, wherein the first data unit is followed by the second data unit; and
a laser controller, responsive to the trigger signal, receiving the second data unit from the data buffer, writing the second data unit to the optical disc using the write laser, reading and evaluating the second data unit recorded on the optical disc, adjusting characteristics of the write laser according to the evaluation, receiving the first data unit from the data buffer, and writing the first data unit to the optical disc using the adjusted write laser.

11. The system of claim 10, wherein the first data unit comprises VOB, IFO, file structure information, SDCB, RMD, and navigator table.

12. The system of claim 10, wherein the first data unit comprises data of higher importance than the second data unit.

13. The system of claim 10, wherein the laser controller further identifies the data units in response to the trigger signal.

14. The system of claim 13, wherein the laser controller identifies the first and second data units according to the content thereof.

15. The system of claim 10, wherein the characteristics comprise a power level of the write laser.

16. The system of claim 10, wherein the laser controller detects at least one of the following characteristics of the recorded data: jitter, error rate, and read RF.

17. The system of claim 10, wherein the laser controller further rewrites the second data unit using the adjusted write laser after the first data unit is written.

18. The system of claim 10, wherein when writing the first data unit, the laser controller leaves a gap between a previously recorded portion on the optical disc and an area of the optical disc that stores the first data unit, and concatenates the end of the first data unit to the beginning of the second data unit on the optical disc.

19. A method for writing data onto an optical disc, comprising:
dividing data to be recorded into first and second data units according to a degree of importance of the data;
writing the second data unit of less importance to the optical disc by a write laser;
reading and evaluating the second data unit recorded on the optical disc;
adjusting characteristics of the write laser according to the evaluation; and
writing the first data unit of more importance to the optical disc by the adjusted write laser, such that the end of the first data unit is concatenated to the beginning of the second data unit on the optical disc.

20. The method of claim 19, wherein writing the first data unit of more importance comprises leaving a gap between a previously recorded portion on the optical disc, if any, and an area of the optical disc that stores the first data unit, and concatenating the end of the first data unit to the beginning of the second data unit on the optical disc.
